(19) United States
(12) Patent Application Publication
(10) Pub. No.: US 2008/0000390 A1
(43) Pub. Date: Jan. 3, 2008

(54) Reflective additive-process color genesis with image

(76) Inventor: R. Sloan Wilson JR., New Haven, CT (US)

Correspondence Address: R. SLOAN WILSON, JR., 312 CENTRAL AVE., NEW HAVEN, CT, 06515, US

(21) Appl. No.: 11/807,344

(22) Filed: May 24, 2007

Related U.S. Application Data
(60) Provisional application No. 60/808,328, filed on May 24, 2006.

(30) Foreign Application Priority Data
Nov. 14, 2005 (IB) PCT/IB05/03398

(51) Int. Cl. G03B 19/00; A63H 1/00

(52) U.S. Cl. 106/401

(57) ABSTRACT

An RGB color-mixing process, described in International application PCT/IB05/03398, wherein dark intervals in the form of pigment and/or shadows is included among the red, green, and blue primaries applied directly to the ‘open-work’ structures described in said application.

This application claims the benefit of U.S. Provisional Application No. 60/808,328, filed May 24, 2006, (35 USC 119(e)), and constitutes an improvement upon the additive color-mixing method suggested in International application, No. PCT/IB05/03398, published 18 May, 2006.

### BACKGROUND AND DESCRIPTION

The improvement does not attempt to generate complete color imagery (as indicated in PCT/IB05/03398) but introduces black and or cast shadows upon the openwork of the structures themselves (called Type I in PCT/IB05/03398) as a means to hide or knock out regions of the otherwise colored mesh or openwork. By this method, only the colors of the elements behind the openwork treated with regions of black or shadow will be visible. For example, a red-colored mesh superposed in front of a blue mesh will create an optical mix of magenta or some variant of violet, but with domains of black pigment, or shadows, appied to the front, red mesh, (as in the case of a projected image of white light and shadows, or an image of black pigment applied directly to the mesh), then the only the blue color of the elements behind the front screen will be visible in the ‘knocked-out’ areas.

In application PCT/IB05/03398, there are two ways to make photographic or other images: 1) by changing the dimensions of the aperture and material thickness of the openwork; which might require making a mold and casting, and 2), by varying the color domains on the openwork.

By the above-mentioned improvement, there is no need to physically remove the material to increase the ratio of black—the mesh substrate can remain the same throughout and details of imagery, possibly photographic imagery, are maintained. An openwork cube, or sphere, for instance might have interiors of solid color and exteriors of color with black knock-out regions, (shadows).

I claim:

1. An RGB color-mixing process, described in International application PCT/IB05/03398, wherein dark intervals in the form of pigment and/or shadows is included among the red, green, and blue primaries applied directly to the ‘open-work’ structures described in said application.
